(19) United States
(12) Patent Application Publication
(10) Pub. No.: US 2002/0091508 A1
(43) Pub. Date: Jul. 11, 2002

(54) Emulating exchange for multiple servers

(76) Inventors: Oded M. Hadass, Rishon Le-Zion (IL); Igor Bashes, Herzliya (IL); Meiron Atias, Netanya (IL)

Correspondence Address: FOGG SLIFER & POLGLAZE, P.A., P.O. BOX 581009, MINNEAPOLIS, MN, 55458-1009, US

(21) Appl. No.: 09/758,048

(22) Filed: Jan. 10, 2001

(51) Int. Cl. G06F 9/455

(52) U.S. Cl. 703/25

(57) ABSTRACT

There is disclosed a telephone exchange emulator for POTS and ISDN telephone lines comprising, a main unit including at least one of at least one Plain Old Telephone Service (POTS) line card or at least one Integrated Services Digital Network (ISDN) line card, and at least one V5.1 interface card, each of one of the at least one POTS or the at least one ISDN line card, and the at least one V5.1 interface card in communication with ports. These ports are adapted for receiving signals from communication devices, including for example, POTS and ISDN telephones. There is also a switch simulator in communication with the at least one V5.1 interface card. There is also a controller, typically a workstation with network management software for managing (controlling) the main unit and switch simulator. A method for emulating a telephone exchange is also disclosed.

### TECHNICAL FIELD

The present invention is directed to the field of testing of telecommunication equipment, and in particular, to systems and methods that emulate exchanges that support multiple services, such as Integrated Services Digital Network (ISDN) and Plain Old Telephone Service (POTS).

### BACKGROUND

Access systems are used in telecommunications networks to transport telephony or other services across a network. In a conventional telephone network, access systems function to transport voice and data between the local exchange and the subscribers' equipment, typically located at a business or residential site. For example, commercially available access systems include BroadAccess™ or LightAccess™, both available from ADC Teledata, Herzlia, Israel, both of which support POTS and ISDN services.

Access systems, such as those detailed above, and in particular, those supporting ISDN lines, are typically tested, to determine load on the system and load on the ISDN interfaces. Testing this kind of a system requires ISDN lines for Bit Rate Error (BER) testing, call process testing, traffic testing and various other tests. The use of commercial ISDN lines for this testing procedure is not practical, as large numbers of “lines” must be ordered from a telephone company. Heavy usage of these lines may be costly and the required amount of lines may not be available from the local telephone service provider.

Alternatively, commercial exchange simulators for both POTS and ISDN are available. However, these systems are expensive and have a limited number of lines that for most testing procedures simply are not enough. For example, an Ameritec AM7 (Ameritec Corporation, Covina Calif.) POTS exchange simulator has only twenty POTS lines. Similarly, ISDN exchange simulators, such as those available as the EMUTEL® series of ISDN exchange simulators, from Arca Technologies, 5 Third Street, San Francisco, Calif. 94103, are also limited to eight lines at a high cost. Moreover, both of the above described systems lack flexibility for both ISDN and POTS lines as they support only one line type, ISDN or POTS. As a result, these systems do not support calls between ISDN and POTS lines.

Finally, even if separate simulators for ISDN and POTS lines are employed, testing capability is and remains limited. This is because conventional simulators typically do not communicate with one another, and thus, POTS to ISDN calls as well as ISDN to POTS calls can not be readily simulated.

### SUMMARY

Embodiments of the present invention improve on conventional exchange simulators by allowing a single simulator to present various combinations of services on its communications lines. For example, one embodiment allows for the simulation of ISDN Basic Rate Interface (BRI), POTS and switch interface ports (such as V5.1 and V5.2) in the same system. In this embodiment, testing capacity is increased, when compared to conventional simulators, as the system supports ISDN to POTS as well as POTS to ISDN calls.

One embodiment of the present invention is directed to emulated exchanges comprising a main unit including at least one access device configured for supporting at least one line type, typically two line types, such as POTS and ISDN, and at least one switch interface card, for example a V5.1 interface card, and a plurality of ports in communication with the main unit. These ports are adapted for receiving signals from communication devices. There is also a switch simulator in communication with the at least one switch interface card.

In one embodiment, the switch simulator is configured for emulating a digital exchange, includes V5.1 and/or V5.2 ports, and is designed for processing POTS and/or ISDN data. The main unit typically supports the line types in the form of line cards, typically POTS and ISDN line cards in various combinations. These line cards are in communication with their respective ports. There is also a controller, typically a wokstation with network management software for managing (controlling) the main unit and switch simulator.

Another embodiment is directed to a method for emulating a telephone system exchange. This method includes providing a switch simulator configured for emulating a digital exchange and for opening at least one voice path between connected telephone devices. The method also includes monitoring at least one telephone line corresponding to at least one calling telephone for line conditions, responding to a change in line conditions, signaling the switch simulator to receive dialed digits, activating the switch simulator for placing a call to the telephone line corresponding to the received dialed digits, and initiating a signal for generating a ringing signal to the telephone line of an intended recipient. The intended recipient telephone line corresponds to that of the dialed digits. This method is such that calls can be completed between two POTS telephones, between two ISDN telephones, and between POTS and ISDN telephones.

### BRIEF DESCRIPTION OF THE DRAWINGS

Attention is now directed to the attached drawings, wherein like reference numerals or characters indicate corresponding or like components. In the drawings:

FIG. 1 is a schematic diagram of an embodiment of the invention,

FIG. 2 is a schematic diagram of an exemplary testing set-up employing an embodiment of the invention,

FIG. 3 is a schematic diagram of a second exemplary testing set-up employing an embodiment of the invention, and

FIG. 4 is a schematic diagram of a third exemplary testing set-up employing an embodiment of the invention.

### DETAILED DESCRIPTION

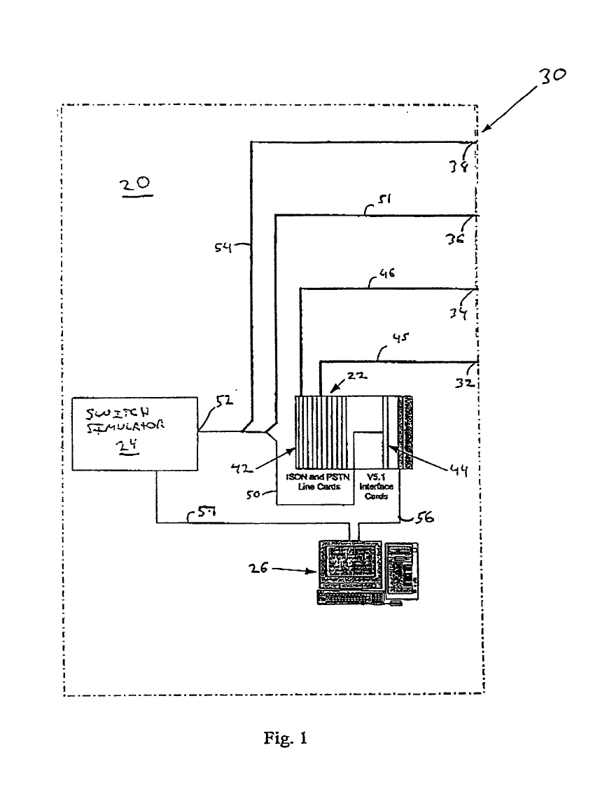

FIG. 1 details a schematic diagram of one embodiment of a system 20 that is adapted to function as an exchange emulator. This system 20 includes a main unit 22 coupled to a switch simulator 24. The main unit 22 and switch simulator 24 are connected to a computer 26. Computer 26 configures and manages the operation of the main unit 22 and switch simulator 24. The system 20 terminates in an interface 30 that accommodates POTS ports 32, ISDN ports 34, typically defining a “U” interface, V5.1 ports 36 and V5.2 ports 38. It is understood that the port types identified here are provided by way of example and not by way of limitation. In other embodiments, ports for other acceptable line types and switch interfaces are provided.

The main unit 22 is an access device, that is configured to be a single unit primary access multiplexer. Its configuration is such that it typically supports single or multiple POTS and single or multiple ISDN line cards in the same subrack 42, allowing for a mixed configuration of all ports at the interface 30. Main unit 22 is also configurable to include single or multiple V5.1, or other protocol, interface cards 44. POTS lines 45 and ISDN lines 46 extend from the main unit 22 to the respective ports 32, 34 of the interface 30. In one embodiment, the main unit 22 is a LightAccess™ (TIMUX™), available from ADC Teledata, Herzlia, Israel, the LightAccess™ module functions as a single unit primary access multiplexer modified so as to include V5.1 interface cards 44 and some selected combination of ISDN and POTS cards in subrack 42. This configuration supports up to 150 POTS lines, up to 60 ISDN lines, or a combination of both types of lines.

The switch simulator 24, serves to simulate a digital exchange with, for example, V5.1 and V5.2 ports. Each of the ports at the interface of the switch simulator 52 is adapted to be configured to be either a V5.1 or a V5.2 port or port that supports another appropriate switch protocol. Some of these V5.1 ports connect via line 50 (only one line shown for example) to the V5.1 interface cards 44. Other V5.1 ports connect via line(s) 51 to the V5.1 port(s) 36 at the interface 30. The V5.2 ports connect via another line(s) 54 to the V5.2 ports 38 at the interface 30. In one embodiment, this switch simulator 24 is a V5SWIM™ switch simulator, available from TdSoft, Herzlia, Israel (TdSoft is a Subsidiary of ADC Teledata, Herzlia, Israel), and is adapted to process data from both POTS and ISDN lines once passed therethrough.

The computer 26 is typically a workstation with network management software, for managing the system, and V5SWIM™ configuration software for configuring the system. The V5SWIM™ configuration is provided by the manufacturer of the V5SWIM™ Switch Simulator (TdSoft). The computer 26 connects to the main unit 22 and switch simulator 24, typically by wired links 56, 57. In one embodiment, communication between the computer 26 and switch simulator 24 is by a protocol such as TCP/IP, and communication between the computer 26 and the main unit 22 is by a RS232 protocol.

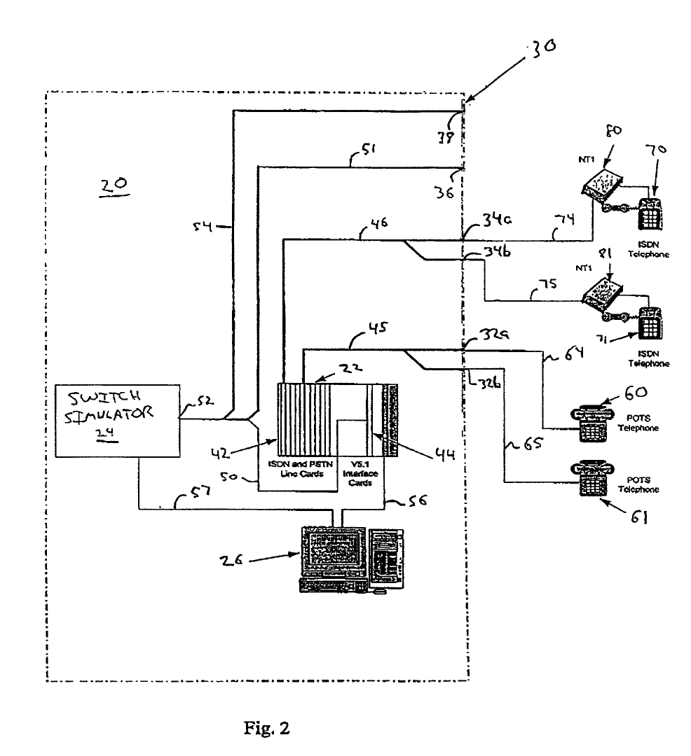

FIG. 2 details an exemplary operation of the system 20 in a test set-up. Here, a POTS telephone 60 is connected to one of the POTS ports 32a by line 64, and it initiates an outgoing call to another POTS telephone 61, connected to another one of the POTS ports 32b, by line 65. When the handset is picked up, the main unit 22 identifies an “off-hook” condition and converts it to an “off-hook” message to the switch simulator 24. The switch simulator 24 responds by activating the relevant line and generating a dial-tone to the line. The main unit 22 transfers the dial-tone to the telephone 60. The user then dials a number on the telephone 60, either by pulse or by Dual-Tone-Multi-Frequency (DTMF) dialing. If pulse dialing is used, the main unit 22 converts the dialed digits to messages, which are transferred to the switch simulator 24 via line 50 to the specific V5.1 interface 52. If DTMF dialing is used, the digits are transferred to the switch simulator 24 on the voice-path via line 50 to the V5.1 interface 52.

In either case, the switch simulator 24 analyzes the dialed digits, and initiates a call to the specific line. Here, the specific line is the line connected to the telephone 61. The switch simulator 24 initiates a ringing message to the main unit 22, which generates a ringing signal to the telephone 61. When the telephone 61 is answered (picked up), the main unit 22 generates an off-hook message to the switch simulator 24. The switch simulator 24 generates an “end of ring” message, that causes the main unit 22 to stop ringing the telephone 61. The switch simulator 24 also opens the voice-path between the two telephones 60, 61, and thus, the call, has been established.

In a similar way, system 20 is adapted to allow a POTS Telephone 60, 61, for example, to initiate a call to an ISDN telephone 70, 71, for example, connected by lines 74, 75, to one of the ISDN ports 34a, 34b via lines 74, 75 through the respective Network Termination Unit (NT1) 80, 81. Also, system 20 is adapted to allow the ISDN telephone 70 to initiate a call to a POTS telephone 60, or to another ISDN telephone 71, connected through the other NT1 81.

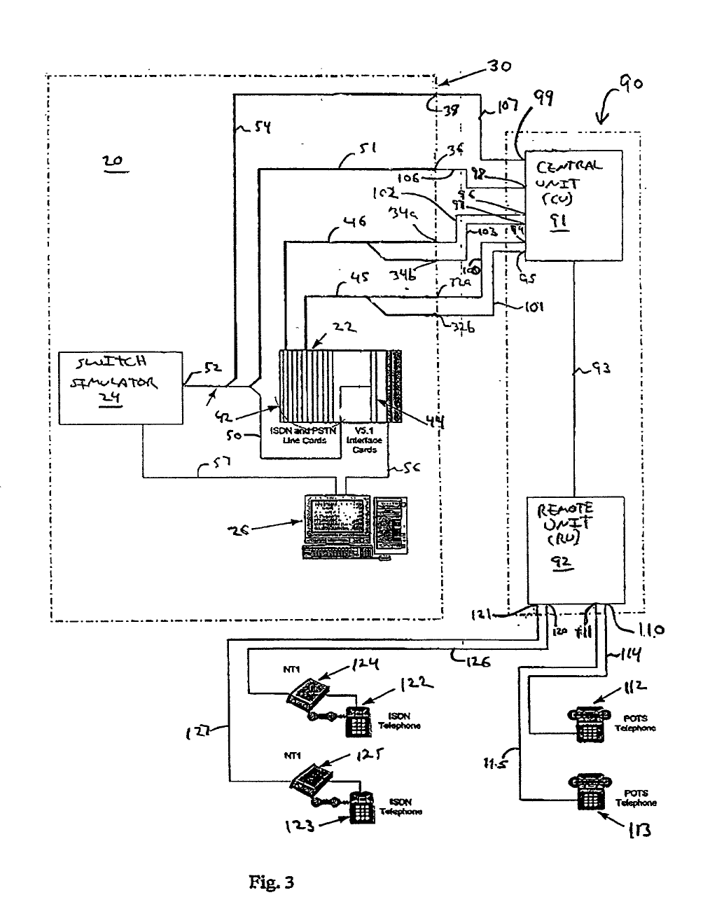

FIG. 3 details a second exemplary operation of the system 20 in a test set-up, which is used for testing an access system 90, for example a BroadAccess™ access system. The BroadAccess™ is formed from two units, a Central Unit (CU) 91, and a Remote Unit (RU) 92, connected by a link 93. The link 93 is a wired, typically fiber or copper, wireless or other appropriate link. The CU 91 interfaces with the exchange emulator 20 with any of a number of different interfaces. For example, in one embodiment, the CU 91 provides any appropriate combination of POTS interfaces 94, 95, ISDN (U) interfaces 96, 97, V5.1 interfaces 98 and V5.2 interfaces 99. In this exemplary operation, each one of the interfaces is connected to the respective matching ports 32a, 32b, 34a, 34b, 36 and 38 in the system 20.

Specifically, from the CU 91, lines 100, 101 connect the POTS interfaces 94, 95 to the respective POTS ports 32a, 32b of the system 20. The ISDN interfaces 96, 97 are connected by lines 102, 103 to the respective ISDN ports 34a, 34b of system 20. The V5.1 interface 98 connects to the V5.1 port(s) 36 of the system 20 connected by lines 106, and the V5.2 interface 99 connects to the V5.2 port(s) 38 of the system 20 by lines 107.

The Remote Unit (RU 92) has POTS interfaces 110, 111, for connecting to the respective POTS telephones 112, 113 via the respective lines 114, 115, and ISDN interfaces 120, 121, for connecting to the respective ISDN telephones 122, 123, through ISDN NTs 124, 125, typically NT1 units, over lines 126, 127, respectively.

In this exemplary operation, a POTS telephone 112 is connected to one of the POTS interface 110 of the RU 92 by a line(s) 114, and it initiates an outgoing call to another POTS telephone 113, connected to another one of the POTS interfaces 111 by line(s) 115. When the handset of telephone 112 is picked up, the RU 92 identifies an “off-hook” condition at its interface 110, and transfers it to the CU 91 through the link 93. In this example, the CU 91 reproduces the “off-hook” signal at its corresponding POTS interface 94. The “off-hook” signal is transferred by line 100 to the POTS port 32a of system 20. The main unit 22 identifies an “off-hook” condition, and converts it to an “off-hook” message to the switch simulator 24.

The switch simulator 24 responds by activating the relevant line and generating a dial-tone to the line. The main unit 22 transfers the dial-tone to the relevant POTS port 32a, and is transferred back through line 100 to the POTS interface 94 of the CU 91. The CU 91 transfers the dial tone through the link 93 to the corresponding POTS interface 110 of the RU 92, which transfers it by line 114 to the telephone 112.

Upon hearing a dial tone, the user then dials a number on the telephone 112, either by pulse or by Dual-Tone-Multi-Frequency (DTMF) dialing. If pulse dialing is used, the pulses are transferred from the RU 92 through link 93 to the CU 91, and then to the system 20. The main unit 22 converts the dialed digits to messages, which are transferred to the switch simulator 24 via line 50 to the specific V5.1 interface 52. If DTMF dialing is used, the digits are transmitted from the RU 92 through link 93 to the CU 91, and then transferred to the switch simulator 24 on the voice-path via line 50 to the V5.1 interface 52.

In either case, the switch simulator 24 analyzes the dialed digits, and initiates a call to the specific line. Here, the specific line is the line connected to the telephone 113 through the access system 90. The switch simulator 24 initiates a ringing message to the main unit 22, which generates a ringing signal at the POTS interface 33, corresponding to the called line, of the system 20. The POTS port 32b is connected to the POTS interface 95 of the CU 91, by line 101. The ring detector at the POTS interface 95 of the CU 91, detects the ringing signal, and transfers it through link 93 to the RU 92, which reproduces the ringing signal at its corresponding POTS interface 111. This causes the telephone 113 to ring.

When the telephone 113 is answered (picked up), this is identified as an “off-hook” condition at the POTS interface 111 of the RU 92, which transfers it through link 93 to the CU 91. The CU 91 reproduces the “off-hook” condition at its corresponding POTS interface 95, which is transferred by line 101 to the POTS port 32b of the system 20. The main unit 22 generates an off-hook message to the switch simulator 24. The switch simulator 24 generates an “end of ring” message, that causes the main unit 22 to stop ringing at POTS port 32b. This stops the CU 91 from identifying a ringing signal at its POTS interface 95, and it therefore stops transferring a ring message to the RU 92 through the link 93. This causes the telephone 113 to stop ringing. The switch simulator 24 also opens the voice-path between the two POTS ports 32a, 32b, which are connected through the access system 90 to telephones 112, 113, and thus, the call has been established.

In a similar way, system 20 is adapted to allow a POTS Telephone 112, 113, for example, to initiate a call to an ISDN telephone 122, 123, through the respective Network Termination Unit (NT1) 124, 125. Also, system 20 is further adapted to allow the ISDN telephone 122 to initiate a call to a POTS telephone 112, or to another ISDN telephone 123, connected through the other NT1 125.

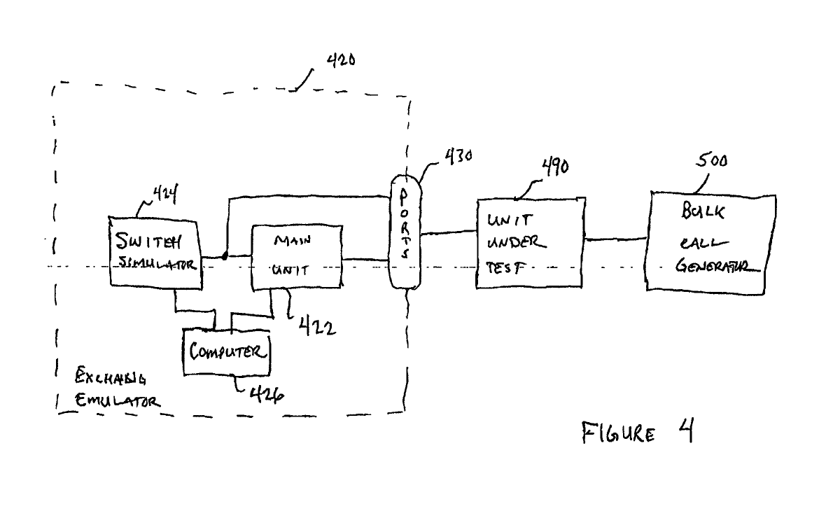

FIG. 4 is a schematic diagram of a third exemplary testing set-up employing an embodiment of the invention. In this embodiment, exchange emulator 420 and bulk call generator 500 combine to test the operation of unit under test 490. Unit under test 490, comprises, for example, an access system such as a digital loop carrier (DLC) or other appropriate communication circuit.

Exchange emulator 420 provides an interface at ports 430 for unit under test 490. Ports 430 comprise ports that support one or more of V5.1, V5.2, or other appropriate switch interfaces, POTS, ISDN, or other line or service type. Ports 430 are coupled to main unit 420 and switch simulator 424. Main unit 422 comprises, in one embodiment, an access device that is configured to be a single unit primary access multiplexer. In one embodiment, main unit 422 is a LightAccess (TIMUX), available from ADC Teledata, Herzlia, Israel. In one embodiment, the LightAccess module functions as a single unit primary access multiplexer modified so as to include V5.1 interface cards and some selected combination of ISDN and POTS cards in a single subtrack. This configuration supports up to 150 POTS lines, up to 60 ISDN lines, or a combination of both types of lines. In other embodiments, the main unit 20 includes line and interface cards for other appropriate line types and switch interfaces.

Switch simulator 424, serves to simulate a digital exchange with at least one of V5.1 and V5.2 ports coupled to ports 430. In one embodiment, this switch simulator 424 is a V5SWIM switch simulator, available from TdSoft, Herzlia, Israel (TdSoft is a Subsidiary of ADC Teledata, Herzlia, Israel), and can process data from both POTS and ISDN lines once passed therethrough.

The computer 426 is typically a workstation with network management software, for managing the exchange emulator 420, and V5SWIM configuration software for configuring switch simulator 424. The V5SWIM configuration is provided by the manufacturer of the V5SWIM Switch Simulator (TdSoft). In one embodiment, communication between the computer 426 and switch simulator 424 is by a protocol such as TCP/IP, and communication between the computer 426 and the main unit 422 is by a RS232 protocol.

In one embodiment, unit under test 490 is monitored during operation to determine load on the system, load on ISDN interfaces, Bit Rate Error (BER) performance, call processing performance, traffic handling and various other characteristics of the unit under test. In one embodiment, this analysis is performed based on data monitored by computer 426 and bulk call generator 500.

Bulk call generator 500 generates calls to be processed by unit under test 490. Bulk call generator 500 generates calls of at least two service types. For example, bulk call generator 500, in one embodiment, generates POTS and ISDN calls. In one embodiment, bulk call generator 500 is constructed as described in commonly assigned, co-pending application Ser. No. 09/593,903, filed on Jun. 14, 2000 and entitled BULK CALL GENERATOR (the 903 Application). The 903 Application is incorporated herein by reference. In this embodiment, calls of a first line type processed by unit under test 490 are selectively connected by exchange emulator 420 to lines of either the first or second line type.

In operation, bulk call generator 500 generates calls that are designed to test the operation of unit under test 490. For example, bulk call generator 500 generates a number of calls n lines of one or more line types, e.g., lines that support ISDN and POTS services. These calls are processed by unit under test 490 and passed to exchange emulator 420 at ports 430. Main unit 422 provides signals to switch simulator 424 to make the connection. Switch simulator 424 generates signals that connect through port 430 to a line of one of the supported line types. Computer 426 and bulk call generator 500 monitor the operation to allow analysis of the operation of unit under test 490.

While embodiments of the present invention have been described, so as to enable one of skill in the art to practice the present invention, the preceding description is intended to be exemplary only. It should not be used to limit the scope of the invention, which should be determined by reference to the following claims.

What is claimed is:

1. An emulated exchange comprising:
a main unit including at least one access device configured for supporting at least one line type and at least one switch interface card;
a plurality of ports in communication with said main unit, said ports adapted for receiving signals from communication devices; and
a switch simulator in communication with said at least one switch interface card.

2. The emulated exchange of claim 1, wherein said at least one line type includes at least a first line type and a second line type.

3. The emulated exchange of claim 2, wherein said main unit additionally comprises:
at least one of a first line card corresponding to said first line type and at least one second line card corresponding to said second line type, said at least one first line card and said at least one second line card in communication with said ports.

4. The emulated exchange of claim 3, wherein said first line card is adapted for Plain Old Telephone System (POTS) line types.

5. The emulated exchange of claim 3, wherein said second line card is adapted for Integrated Services digital Network (ISDN) line types.

6. The emulated exchange of claim 2, additionally comprising:
a controller in communication with said main unit and said switch simulator, said controller for configuring and managing the operation of said main unit and said switch simulator.

7. The emulated exchange of claim 1, wherein said at least one switch interface card includes at least one V5.1 interface card.

8. The emulated exchange of claim 4, wherein said port in communication with said at least one POTS line card is adapted for receiving communications from POTS telephones.

9. The emulated exchange of claim 5, wherein said port in communication with said at least one ISDN line card is adapted for receiving communications from ISDN telephones.

10. The emulated exchange of claim 1, wherein said switch simulator is configured for emulating a digital exchange and includes at least one of V5.1 ports or V5.2 ports.

11. The emulated exchange of claim 10, wherein said switch simulator is configured for processing POTS data.

12. The emulated exchange of claim 10, wherein said switch simulator is configured for processing ISDN data.

13. A method for emulating a telephone system exchange, the method comprising:
providing a switch simulator configured for emulating a digital exchange and opening at least one voice path between connected telephone devices;
monitoring at least one telephone line corresponding to at least one calling telephone for line conditions;
responding to a change in line conditions;
signaling said switch simulator to receive dialed digits;
activating said switch simulator for placing a call to the telephone line corresponding to the received dialed digits; and
initiating a signal for generating a ringing signal to the telephone line of an intended recipient, said intended recipient telephone line corresponding to said dialed digits.

14. The method of claim 13, wherein said step of monitoring at least one telephone line includes monitoring for an off-hook condition in said at least one calling telephone line.

15. The method of claim 13, wherein said step of responding to a change in line condition includes generating a dial tone to said at least one calling telephone line.

16. The method of claim 13, wherein said step of signaling said switch simulator to receive said dialed digits includes converting pulse dialed digits to messages.

17. The method of claim 13, wherein said step of signaling said switch simulator to receive said dialed digits includes transferring Dual Tone Multi-Frequency (DTMF) dialed digits over a voice path to said switch simulator.

18. The method of claim 13, wherein said at least one calling telephone line is an ISDN line.

19. The method of claim 13, wherein said at least one calling telephone line is a POTS line.

20. The method of claim 13, wherein said intended recipient telephone line is an ISDN line.

21. The method of claim 13, wherein said intended recipient telephone line is a POTS line.

22. An emulated exchange comprising:
a main unit including at least one access device configured for supporting first and second line types and at least one switch interface;
a switch simulator, coupled to the switch interface of the main unit, to selectively switch calls of the first and second line types; and
a port, coupled to the main unit, said port adapted to provide lines of the first and second line types for the emulated exchange.

23. The emulated exchange of claim 22, wherein the main unit includes POTS and ISDN line cards.

24. The emulated exchange of claim 22, wherein the main unit includes one of a V5.1 and a V5.2 switch interface card.

25. An exchange emulator, comprising:
an access device, the access device including:
a subrack;
a plurality of line cards disposed in the subrack, each line card supporting at least one of the first and second line types; and
a switch interface card, communicatively coupled to the plurality of line cards in the subrack;
a switch simulator, coupled to the switch interface card of the access device, the switch simulator adapted to simulate a digital exchange; and
a number of ports, selectively coupled to the plurality of line cards and the switch simulator.

26. The exchange emulator of claim 25, wherein each line card supports one of ISDN and POTS line types.

27. The exchange emulator of claim 25, wherein the switch interface card comprises one of a V5.1 and V5.2 switch interface card.

28. A method for testing a unit under test, the method comprising:
generating a plurality of calls for lines of first and second line types;
processing the plurality of calls in the unit under test;
generating signals for a switch to connect the plurality of calls of each of the first and second line types;
selectively switching calls for the first and second line types; and
monitoring the operation of the unit under test.

29. The method of claim 28, wherein generating a plurality of calls comprises generating a plurality of calls for ISDN and POTS lines.

30. The method of claim 28, wherein selectively switching calls for the first and second line types includes:
selectively switching calls of the first line type to a line of one of the first and second line types based on the generated signals; and
selectively switching calls of the second line type to a line of one of the first and second line types based on the generated signals.

31. The method of claim 28, wherein processing the calls in the unit under test comprises processing the calls in an access device.

32. The method of claim 28, wherein generating a plurality of calls comprises generating a plurality of calls with a bulk call generator of the first line type.

33. The method of claim 32, and further including selectively converting some of the first line type to the second line type.

34. The method of claim 28, wherein monitoring the operation of the unit under test comprises monitoring at least one of load on the system, load on ISDN interfaces, Bit Rate Error (BER) performance, call processing performance, traffic handling.
